(19) United States
(12) Patent Application Publication
(10) Pub. No.: US 2026/0369969 A1
(43) Pub. Date: Nov. 19, 2026

(54) SPARK PLUG SEALING MATERIAL

(71) Applicant: Federal-Mogul Ignition LLC, Northville, MI (US)

(72) Inventors: William J. Walker, Kingston, NY (US); Joseph M. Keller, Grand Blanc, MI (US)

(21) Appl. No.: 19/206,713

(22) Filed: May 13, 2025

(51) Int. Cl. H01T 13/08; H01T 21/02

(52) U.S. Cl. CPC H01T 13/08; H01T 21/02

(57) ABSTRACT

A spark plug sealing material for sealing a space between a spark plug insulator and shell, where the material includes a low extrusion powder material having angular and/or interlocking particles that resist being pushed or extruded out of the space during manufacture. The sealing material may include the low extrusion powder material (e.g., aluminum oxide), at least one additive material, and at least one binder material. The angular and/or interlocking nature of the aluminum oxide particles can help resist the flow of the low extrusion powder in the space between the insulator and shell when it is compressed under significant force, thereby reducing undesirable material loss.

### FIELD

This disclosure generally relates to spark plugs, and more particularly, to sealing materials that seal a space between a spark plug insulator and shell, as well as methods of manufacture.

### BACKGROUND

Most spark plugs have elongated insulators made from ceramic materials secured within axial bores of shells made from metallic materials. An insulator usually has one or more annular shoulders formed on an exterior surface that are supported by one or more corresponding annular shoulders formed on an internal surface of a shell. The annular space or volume between the exterior of the insulator and the interior of the shell is typically filled with a sealing material in the form of talc powder (e.g., magnesium silicate).

During manufacture, once the insulator has been inserted in the axial bore of the shell and the talc powder has been tamped into the annular space between the two components, an annular turnover flange at the top of the shell is bent downwardly against the talc powder and locks the components in place. The downward force with which the turnover flange is bent is transferred into the tamped talc powder and helps compress the powder to a high density. Since talc powder is a relatively soft material and includes plate-like particles that can easily slide past one another, the downward forces from the bent turnover flange can sometimes cause some of the talc powder to be pushed or extruded out of small gaps between the insulator and shell. This loss of material is undesirable, as it reduces the seal between the two components and can even result in failure of the spark plug.

Therefore, there is a need for sealing materials that provide adequate sealing between spark plug insulators and shells but also reduce undesirable powder extrusion and material loss, as mentioned above.

### SUMMARY

According to one embodiment, there is provided a spark plug sealing material for sealing an annular space between a spark plug insulator and a spark plug shell, the sealing material comprising: a low extrusion powder material having an internal friction that is higher than that of talc powder, wherein the low extrusion powder material is the single largest constituent of the sealing material on a wt% basis.

In accordance with the various embodiments, the spark plug sealing material may have any one or more of the following features, either singly or in any technically feasible combination:
the low extrusion powder material is aluminum oxide (Al₂O₃);
the sealing material further comprises at least one additive material;
the at least one additive material is a reclaimed material from a process used to manufacture spark plug insulators;
the sealing material further comprises at least one binder material,
the at least one binder material is polyvinyl alcohol (PVA), polyethylene glycol (PEG), a PVA/PEG organic binder system, or a wax emulsion;
the sealing material is comprised of 90-99 wt % low extrusion powder material in the form of aluminum oxide (Al₂O₃), 0.5-5 wt % at least one binder material, and 0.5-5 wt % at least one additive material;
the low extrusion powder material has a median particle size of 10 μm or less;
the low extrusion powder material has an average particle shape that is generally solid, angular and rock-like;
the low extrusion powder material has a coefficient of friction that is 0.5-0.7, inclusive;
the low extrusion powder material is at least one of: a material from the chemical system MgO·Al₂O₃·SiO₂ or silicon carbide (SiC); and
the sealing material is designed to be compacted in the annular space between the spark plug insulator and the spark plug shell to a density of at least 85% of a theoretical density of the sealing material.

According to another embodiment, there is provided a spark plug comprising: a shell having an axial bore and an internal surface; an insulator at least partially disposed within the axial bore of the shell and having an axial bore and an external surface; a center electrode at least partially disposed within the axial bore of the insulator; a ground electrode forming a spark gap with the center electrode; an annular space located between the internal surface of the shell and the external surface of the insulator; and a spark plug sealing material disposed within the annular space, wherein the sealing material includes a low extrusion powder material having an internal friction that is higher than that of talc powder, the low extrusion powder material is the single largest constituent of the sealing material on a wt % basis.

According to yet another embodiment, there is provided a method of manufacturing a spark plug, comprising the steps of: providing a sealing material comprising a low extrusion powder material having an internal friction that is higher than that of talc powder, wherein the low extrusion powder material is the single largest constituent of the sealing material on a wt % basis; introducing the sealing material into an annular space between a spark plug insulator and a spark plug shell; tamping the sealing material down; and bending a turnover flange into place so that the turnover flange presses against and further compacts the sealing material.

In accordance with the various embodiments, the method of manufacturing may have any one or more of the following features, either singly or in any technically feasible combination:
the low extrusion powder material is aluminum oxide (Al₂O₃);
the sealing material further comprises at least one additive material that is a reclaimed material from a process used to manufacture spark plug insulators;
the sealing material further comprises at least one binder material that is polyvinyl alcohol (PVA), polyethylene glycol (PEG), a PVA/PEG organic binder system, or a wax emulsion;
the introducing step further comprises forming the sealing material into a preform before introducing the preform into the annular space; and
the bending step further comprises bending the turnover flange into place with a pressing pressure of 200-300 Mpa, inclusive, so that the turnover flange presses against and further compacts the sealing material to a density of at least 85% of a theoretical density of the sealing material.

### DRAWINGS

Preferred example embodiments will hereinafter be described in conjunction with the appended drawings, wherein like designations denote like elements, and wherein:

FIG. 1 is a cross-sectional view of an example of a spark plug that may include the sealing material of the present application;

FIG. 2 is a micrograph of aluminum oxide particles that may be part of the spark plug sealing material of the present application; and

FIG. 3 is a micrograph of common talc particles that are part of a spark plug sealing material for conventional spark plugs.

### DESCRIPTION

The spark plug sealing material disclosed herein is used to seal a space between a spark plug insulator and shell and includes a low extrusion powder material having angular and/or interlocking particles that resist being pushed or extruded out of the space during manufacture. According to one example, the spark plug sealing material includes the low extrusion powder material, at least one additive material, and at least one binder material. Instead of a traditional talc powder (magnesium silicate), which has plate-like particles that can easily slide past one another when compressed under significant force, the low extrusion powder material may include aluminum oxide particles that are more angular and/or interlocking than those typically found in talc. The angular and/or interlocking nature of the aluminum oxide particles can help resist the flow of the low extrusion powder in the space between the insulator and shell when it is compressed under significant force. According to one manufacturing example, the spark plug sealing material is inserted, in powder form, into the annular space between the insulator and shell and is then tamped down to a certain density before the turnover flange is bent into place. According to a different manufacturing example, the spark plug sealing material is first pressed into a preform, the preform is then inserted and tamped in the annular space between the insulator and shell, after which the turnover flange is bent into position. Of course, other examples and manufacturing methods are certainly possible.

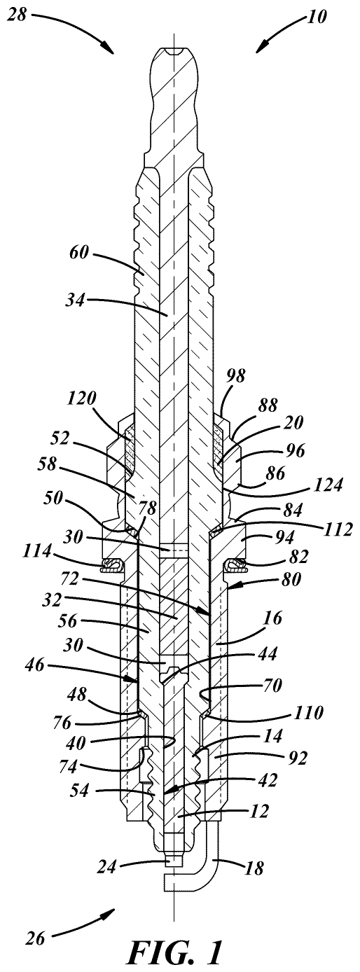

FIG. 1 illustrates an example spark plug 10 that may include the sealing material disclosed herein. According to this particular embodiment, spark plug 10 includes a center electrode 12, an insulator 14, a metallic shell 16, a ground electrode 18, and the spark plug sealing material 20 of the present application. Spark plug 10 is an example of an automotive spark plug that has a J-gap configuration with a spark gap G formed between the center electrode 12 and the ground electrode 18. However, it should be appreciated that the spark plug sealing material and methods described herein may be used with any suitable type of spark plug or ignition device, including other automotive plugs, glow plugs, industrial plugs, aviation igniters and/or any other device that is used to ignite an air/fuel mixture in an engine.

Center electrode 12 is an elongated electrode that, in cooperation with opposing ground electrode 18, forms a spark gap G. The center electrode 12 is disposed within an axial bore of the insulator 14 and may or may not include a separate firing tip. In one embodiment, the center electrode 12 does not include a separate firing tip such that a sparking surface facing the spark gap G is simply made from the same nickel-based material (e.g., Inconel 600, 601) as the center electrode body. In another embodiment, center electrode 12 includes a separate firing tip 24 made from a precious metal-based material (e.g., an iridium-, platinum- or ruthenium-based material) that is attached to or formed on an end of the center electrode body and provides the sparking surface. In yet another embodiment, the center electrode 12 includes a multi-piece firing tip with a first component made from an intermediary material (e.g., a nickel-based material) and a second component made from a precious metal-based material, where the first component is attached to the center electrode body and acts as an intermediary or stress-relieving layer, and the second component is attached to the first component and acts as a firing tip with a sparking surface. In the various embodiments above, which are simply non-limiting examples of potential center electrodes, the firing tips and/or components may be attached via laser welds, resistance welds, or some other suitable welded or non-welded joints. The center electrode 12 is part of a center wire assembly that extends within the axial bore of the insulator and may include any number of suitable center wire components, such as: fired inner seals 30 for helping to retain the center wire assembly components in place, a suppressor seal 32 for helping to suppress radio frequency (RF) interference or noise generated by the spark plug, and a terminal electrode 34 for connecting the spark plug to an ignition system. Other center electrode arrangements and embodiments are certainly possible.

Insulator 14 is an elongated insulative component that is preferably made from a ceramic or other dielectric material and electrically insulates the center electrode 12 from the metallic shell 16. According to one example, insulator 14 is made from an alumina-based material (e.g., greater than 95 wt % aluminum oxide (Al₂O₃), with small amounts of one or more sintering aids generally making up the balance (e.g., magnesium oxide (MgO), yttrium oxide (Y₂O₃), and/or zirconium oxide (ZrO₂)), however, other insulator materials are certainly possible. Insulator 14 is at least partially disposed or located within an axial bore of metallic shell 16 and may include an insulator axial bore 40, an internal surface 42 with one or more internal shoulder(s) 44, an external surface 46 with one or more external shoulder(s) 48, 50 and 52, a nose section 54, an intermediate section 56, an enlarged section 58, and a terminal section 60.

Axial bore 40 extends the entire axial length of the insulator 14 and may be configured to receive the center wire assembly such that the center electrode 12 extends out of the axial bore near a firing end 26 and the terminal electrode 34 extends out of the axial bore near an opposite, terminal end 28. The internal surface 42 largely coincides with the surface of the axial bore 40 and may have one or more internal shoulder(s) 44 located at different axial positions along the axial bore. As illustrated in FIG. 1, internal shoulder 44 is an annular shoulder or step portion that occurs at a change in the inner diameter of axial bore 40 and provides a seat to support a corresponding external shoulder of the center electrode 12. External surface 46 includes external shoulders 48, 50 and 52 at each change or transition in the outer diameter of the insulator and, like their internal shoulder counterparts, are annular shoulders that circumferentially extend around the insulator. Some external shoulders, like shoulders 48 and 50, are located at transitions where the outer diameter of the insulator gets smaller, when moving from terminal end 28 to firing end 26; these external shoulders face the firing end 26. Other external shoulders, like shoulder 52, occur at transitions where the insulator outer diameter gets larger, when moving from terminal end 28 to firing end 26; these external shoulders face the terminal end 28. In the embodiment of FIG. 1, insulator 14 only has a single internal shoulder 44 and three external shoulders 48, 50 and 52 (two of which face firing end 26, one of which faces terminal end 28); however, this is just one non-limiting example, as many different embodiments with different combinations and arrangements of internal and/or external shoulders are possible.

Nose section 54 generally extends from external shoulder 48 down to the firing end 26 and may be provided according to any number of different embodiments. For instance, nose section 54 may have a continuous and uniform taper along its axial extent, or it could have sections of differing taper or no taper at all (i.e., straight sections where the outer surfaces are parallel to one another). The nose section 54 may include one or more annular rib(s) to limit or prevent carbon fouling and other build-up. Moreover, the extent to which the nose section 54 axially extends or protrudes beyond the end of the metallic shell 16 (sometimes referred to as the “projection”), may be greater or less than that shown in FIG. 1. It is even possible for the distal end or firing end of the nose section 54 to be retracted within the shell axial bore so that it does not extend beyond the metallic shell at all (i.e., a negative projection).

Intermediate section 56 generally extends between external shoulders 48 and 50 and is located above and adjacent to nose section 54 in FIG. 1. In this particular example, the majority of the intermediate section 56 is located and retained within an axial bore of the metallic shell 16 and surrounds the fired seals 30 and suppressor seal 32 of the center wire assembly. The outer diameter of the intermediate section 56 may be tapered or uniform along its length or it may have both tapered and straight sections, to cite several possibilities.

Enlarged section 58 generally extends between external shoulders 50 and 52 and is located above and adjacent to intermediate section 56 in FIG. 1. As its name suggests, the enlarged section 58 preferably has a diametrically-enlarged shape so that during a spark plug assembly process, an open end or turnover flange of the metallic shell 16 can be folded over or otherwise mechanically deformed in order to securely retain the insulator 14 in place. The turnover flange also traps the spark plug sealing material of the present application in between the external surface 46 of the insulator and an internal surface of the metallic shell 16, as will be explained. Other intermediate section features and embodiments are certainly possible as well.

Terminal section 60 is at the opposite end of the insulator 14 as the nose section 54 and generally extends from external shoulder 52 up to the terminal end 28 such that it is located above and adjacent to enlarged section 58 in FIG. 1. In the illustrated embodiment, the terminal section 60 is quite long and has a series of annular ribs, however, it may be shorter and/or have other configurations instead (e.g., no annular ribs).

Shell 16 is an elongated metallic component that securely holds the other spark plug components in place and screws into a threaded hole in an engine cylinder head in order to provide a ground connection and complete the electrical circuit. Shell 16 is also designed to transfer heat away from the hot sections of the spark plug for dissipation in the cylinder head where there are cooling channels, etc. According to one example, shell 16 is made of steel and is plated and includes a shell axial bore 70, an internal surface 72 with one or more internal shoulder(s) 74, 76 and 78, an external surface 80 with one or more external shoulder(s) 82, 84, 86 and 88, a threaded section 92, an enlarged or barrel section 94, an engagement or hex section 96, and a turnover flange 98.

Axial bore 70 extends the entire axial length of shell 16 and may be configured to receive insulator 14 such that an end portion of the nose section 54 extends out of the axial bore near firing end 26 and the terminal section 60 extends out of the axial bore towards the terminal end 28. The internal surface 72 of the shell largely coincides with that of the axial bore 70 and may include one or more internal shoulder(s) 74, 76, 78 located at different axial positions along the axial bore. Internal shoulder 74 is an annular shoulder that occurs at a change in the inner diameter of axial bore 70; in this case, shoulder 74 is located where the inner diameter gets larger, when moving from terminal end 28 to firing end 26, and therefore faces the firing end. Each of the internal shoulders 76, 78 is located at a transition where the inner diameter of axial bore 70 gets smaller, when moving from terminal end 28 to firing end 26, and provides a seat to support a corresponding external shoulder of the insulator 14. Internal shoulders 76, 78 of the shell face the terminal end 28 and are configured to support external shoulders 48, 50 of the insulator with some type of suitable sealing ring or gasket 110, 112, respectively, interposed therebetween. External surface 80 includes external shoulders 82, 84, 86 and 88 at each change or transition in the outer diameter of the shell and, like their internal shoulder counterparts, are annular shoulders that circumferentially extend around the shell. External shoulders 82 and 86 are located at transitions where the outer diameter of the shell gets smaller, when moving from terminal end 28 to firing end 26; these external shoulders face the firing end 26. External shoulders 84 and 88 occur at transitions where the shell outer diameter gets larger, when moving from terminal end 28 to firing end 26; these external shoulders face the terminal end 28. In the embodiment of FIG. 1, shell 16 has three internal shoulders 74, 76 and 78 and four external shoulders 82, 84, 86 and 88 (two of which face firing end 26, two of which face terminal end 28); however, this is just one non-limiting example, as other embodiments with different combinations and arrangements of internal and/or external shoulders are certainly possible.

Threaded section 92 generally extends from external shoulder 82 down to the firing end 26 and may be provided according to any number of different embodiments. For instance, threaded section 92 could be sized to fit different threaded holes in the cylinder head (e.g., M8, M10, M12 or M14 plugs), to cite a few possibilities. In the example illustrated in FIG. 1, the spark plug has a rather long reach, which means that the threaded section 92 has a long axial length (e.g., at least 19 mm), however, shorter threaded sections could be used instead. It is also possible for the distal end of threaded section 92 to have a shell skirt or other type of shell extension below the threads or even a pre-chamber cap in the event of a prechamber plug.

Enlarged section 94, sometimes referred to as a barrel or barrel section, is diametrically enlarged compared to adjacent shell sections. In general, the enlarged section 94 extends between exterior shoulders 82 and 84 and is located above and adjacent to threaded section 92 in FIG. 1. Exterior shoulder 82, which is provided at the lower end of enlarged section 94 and acts as a gasket shoulder, is designed to compress an external gasket 114 between the exterior shoulder and a cylinder head when the spark plug is installed in an engine in order to prevent leakage around the threads. External gasket 114 is an annular gasket and may be made from any suitable material, such as steel or copper, and may be folded or unfolded, depending on the application.

Engagement section 96 includes exterior features, such as a hex or the like, that can be engaged by a tool for torquing the spark plug 10 into a threaded hole in the cylinder head. The engagement section 96 generally extends between exterior shoulders 86 and 88 and is located above and adjacent to enlarged section 94 in FIG. 1. According to one embodiment, an annular space or volume 120 exists radially between the terminal section 60 (on the outside of the insulator) and the engagement section 96 (on the inside of the shell) and, in this annular space, is the sealing material 20. For a M8 spark plug, the annular space 120 is preferably packed with between 135 mm³-235 mm³ of sealing material 20; for a M10 plug, the annular space 120 is preferably packed with between 175 mm³-275 mm³ of sealing material 20; and for a M12 plug, the annular space 120 is preferably packed with between 700 mm³-1,000 mm³ of sealing material 20. It should be appreciated that the sealing material 20 of the present application may be used to pack and seal other spaces, annular or otherwise, in the spark plug is not limited to the exemplary annular space 20 shown in FIG. 1.

Turnover flange 98 is an annular flange or projection that is bent, crimped or mechanically swaged inwardly during spark plug assembly such that it encloses the annular space 120 and helps secure the sealing material 20 and insulator 14 in place. The turnover flange 98 is located above and adjacent to engagement section 96 in FIG. 1.

Ground electrode 18 may be attached to a distal end of the metallic shell 16 at the firing end 26 and, in conjunction with the center electrode assembly 12, forms the spark gap G. The ground electrode 18 may or may not include a separate firing tip. In one embodiment, the ground electrode 18 does not include a separate firing tip such that a sparking surface on the side of the ground electrode is simply made from the same nickel-based material (e.g., Inconel 600, 601) as the ground electrode body. In another embodiment, ground electrode 18 includes a separate firing tip (not shown) made from a precious metal-based material (e.g., an iridium-, platinum- or ruthenium-based material) that is attached to or formed on an end or side of the ground electrode body and provides a sparking surface. In yet another embodiment, the ground electrode 18 includes a multi-piece firing tip with a first component made from an intermediary material (e.g., a nickel-based material) and a second component made from a precious metal-based material, where the first component is attached to the ground electrode body and acts as an intermediary or stress-relieving layer and the second component is attached to the first component and acts as a firing tip with a sparking surface. If a firing tip is provided, it can be attached to the ground electrode 18 via laser welds, resistance welds, or some other suitable welded or non-welded joints. Other ground electrode arrangements and embodiments, such as those designed for annular spark gaps, surface or semi-creeping spark gaps, multiple spark gaps, prechamber spark gaps, etc. are certainly possible.

Spark plug sealing material 20, sometimes referred to as sillment, is used to pack and seal the annular space 120 located between the external surface of insulator 14 and the internal surface of shell 16. The sealing material 20 includes a low extrusion powder material, such as aluminum oxide (Al₂O₃), as well as one or more optional constituents like additive material(s) and/or binder material(s). The term “low extrusion powder material,” as used herein, broadly includes any powder material with an internal friction that is higher than that of traditional talc powder (hydrous magnesium silicate (Mg₃Si₄O₁₀(OH)₂)), when compared at similar humidity, moisture and/or other conditions. Internal friction, also referred to as the angle of internal friction, can be measured directly according to ASTM Standard D7891 (e.g., using a Freeman Labs FT4 Powder Rheometer). Coefficient of friction, which is a main input or factor of internal friction, can be measured for powder materials according to ASTM Standard 6682. As mentioned above, traditional talc powder is relatively soft and includes plate-like particles that can easily slide past one another when the powder is compressed under pressure, such as when downward forces are used to bend the turnover flange 98 into place during manufacturing. This can cause some of the talc powder to be pushed or extruded out of small annular gaps 124 located between the insulator 14 and shell 16 (e.g., annular gaps about 0.05 mm in size), which results in an undesirable loss of material. The low extrusion powder material, on the other hand, is designed to resist being extruded out of annular gaps 124, yet still be compressible so that the spark plug sealing material 20 can be compacted to a certain density.

According to one embodiment, sealing material 20 includes a low extrusion powder material in the form of aluminum oxide or alumina (Al₂O₃), where the aluminum oxide is the single largest constituent of the sealing material on a wt % basis. Sealing material 20 may include: 90 wt % or more aluminum oxide, 95 wt % or more aluminum oxide, or 90 to 99 wt % aluminum oxide, to cite a few possibilities. The sealing material 20 may also include at least one binder material and/or additive material. For example, in addition to the low extrusion powder material, sealing material 20 may include 0.5-5 wt % binder material(s) and/or 0.5-5 wt % additive material(s). In one such embodiment, sealing material 20 includes 90-99 wt % aluminum oxide, 0.5-5 wt % binder material(s), and 0.5-5 wt % additive material(s). In another embodiment, sealing material 20 includes 95-99 wt % aluminum oxide, 1-3 wt % binder material(s), and the balance being additive material(s). In yet another embodiment, sealing material 20 includes 95-98 wt % aluminum oxide, about 2 wt % binder material(s), and the balance being additive material(s). Non-limiting examples of additive materials and binder materials are provided below. Unless otherwise specified, wt % ranges provided herein are inclusive of the upper and lower bounds of those ranges (e.g., “90-99 wt % aluminum oxide” includes 90 wt %, 99 wt %, as well as all percentages in between).

The size, shape, surface area and/or other factors can impact the internal friction of a powder material. For example, the low extrusion powder material may include particles having: a median particle size of 75 μm or less, a median particle size of 50 μm or less, a median particle size of 10 μm or less, a median particle size of 4 μm or less, or a median particle size of 2 to 4 μm, inclusive. Experimentation has shown that using aluminum oxide powder with a median particle size within one of the ranges listed above, particularly the 2 to 4 μm range, is particularly well suited for the low extrusion powder material, as it helps sealing material 20 resist being extruded out of annular gaps 124 but is still compressible to a desired density. Appropriate particle size analysis techniques, such as those recited in ASTM E3340-22, may be used to determine the median particle size of the low extrusion powder material.

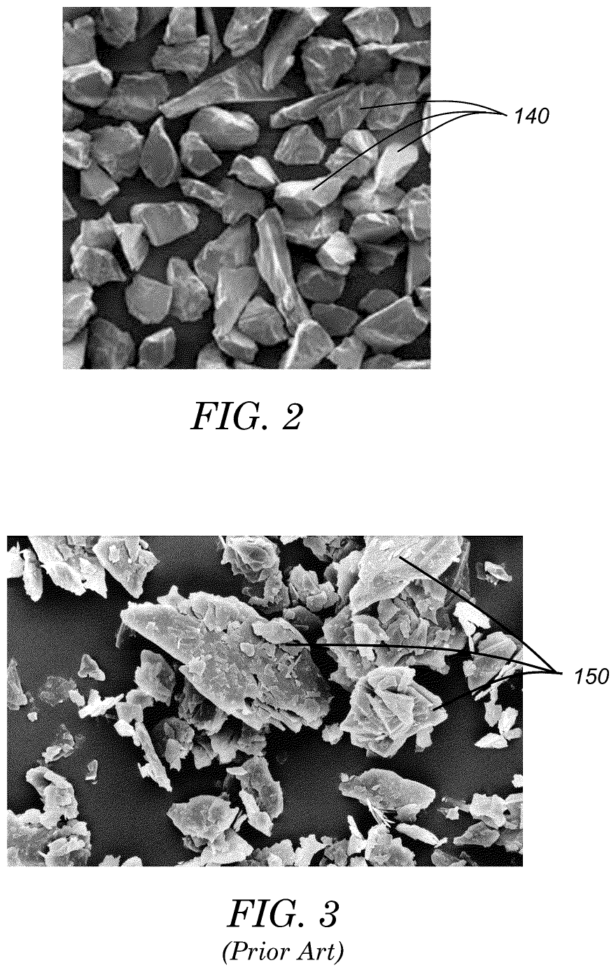

It is also possible for the low extrusion powder material to have particles with an average particle shape or configuration that is generally solid, angular and rock-like. With reference to FIG. 2, there is shown a micrograph (200× times magnification) of aluminum oxide particles 140 for use as the low extrusion powder material where particles 140 are generally solid, angular and rock-like in shape. Tabular alumina and Corundum are two forms of aluminum oxide that are particularly well suited in terms of their shape. This is in contrast with traditional talc powder particles 150 (hydrous magnesium silicate (Mg₃Si₄O₁₀(OH)₂)) which are generally more flat, flaky and plate-like, as demonstrated in the micrograph of FIG. 3 (1000× times magnification). Experimentation suggests that aluminum oxide particles, with their more solid, angular and rock-like configurations, can interlock when subjected to significant pressure so that they are better at resisting flow than traditional talc powder particles. This, in turn, can cause the sealing material 20 to experience less extrusion and material loss during manufacturing. According to one embodiment, the low extrusion powder material has a coefficient of friction of 0.5-0.7 (dry), inclusive, whereas traditional talc has a coefficient of friction of about 0.1-0.3 (dry), inclusive. It is also possible for the low extrusion powder material to have a sliding coefficient that is from 0.7-0.82, inclusive, which is a measure of powder friction at a die wall interface. Aluminum oxide particles with a coefficient of friction that is greater than 0.5 and a sliding coefficient that is greater than 0.7 can demonstrate good compaction while avoiding extrusion out of annular gap 124.

It should be noted that other minerals, ceramics, oxides, carbides, compounds, mixtures and/or blends, other than aluminum oxide, may be used for the low extrusion powder material in sealing material 20. Some non-limiting examples of potential low extrusion powder materials, other than just aluminum oxide, include at least one item selected from the group of: a material from the chemical system MgO·Al₂O₃·SiO₂ (e.g., Mullite (3Al₂O3-2SiO2), Cordierite ((Mg,Fe)₂Al₄Si₅O₁₈) and/or Enstatite (MgSiO₃)) and/or silicon carbide (SiC). Other low extrusion powder materials having internal frictions higher than that of traditional talc powder may be used also.

Binder materials may be added to sealing material 20 to help bind or hold the powder particles together, which can be useful during certain manufacturing processes. Some non-limiting examples of potential binder materials include: polyvinyl alcohol (PVA), polyethylene glycol (PEG), organic binder systems that are a combination thereof, or a wax emulsion (e.g., a blend of microcrystalline wax and paraffin). One such organic binder system is PVA/PEG, which can act as a pressing aid to help bind or hold the sealing material 20 together when the powder is tamped into annular space 120, pressed into a preform, or otherwise processed. According to one example, the binder material is recovered from the process of manufacturing a green or unfired insulator, such as the type used in the formation of insulator 14. This recovery process avoids scrap by reusing binder material that would otherwise be manufacturing process waste. Of course, other binder materials (e.g., organic binders like methylcellulose, poly(propylene carbonate), water based acrylics, carboxymethyl cellulose; or inorganic binders like sodium silicate) may be used instead, as the aforementioned examples only represent some of the possibilities.

Additive material(s) may be added to sealing material 20 to provide the sealing material with desirable density, compaction, sintering and/or other attributes. Non-limiting examples of potential additive material(s) include reclaimed materials from a process used to manufacture spark plug insulators, such as: talc (hydrous magnesium silicate (Mg₃Si₄O₁₀(OH)₂)), calcium carbonate (CaCO₃), kaolin (Al₂Si₂O₅(OH)₄), as well as combinations or blends thereof. In one embodiment, sealing material 20 includes low extrusion powder material in the form of aluminum oxide as a major phase and a combination of additive materials in the form of talc, calcium carbonate, kaolin and/or other reclaimed materials as a minor phase. The major phase helps the sealing material 20 resist being extruded out of small annular gaps 124, whereas the minor phase helps the sealing material be compressible to a desired density. Desired density is generally based on a percentage of the theoretical density of a material and can be important in order for the sealing material 20 to maintain a certain hermiticity. It is preferable that sealing material 20 has a low extrusion powder material in the form of aluminum oxide and that the sealing material be compacted in annular space 120 to a density of: at least 80% of a theoretical density of the sealing material (e.g., at least 3.2 g/cm³ for aluminum oxide) more preferably, at least 3.5 g/cm³; and, even more preferably, at least 3.94 g/cm³.

During manufacture, the sealing material 20 can be added to and processed in the annular space 120 between the spark plug insulator and shell according to several different methods. According to a first method, once insulator 14 has been inserted into the axial bore 70 of shell 16 and is properly seated, sealing material 20 is added or introduced into the annular space 120 and is then tamped down (e.g., tamped down with 200-300 MPa of tamp pressure). Once the sealing material has been adequately tamped or compacted and optionally reamed so that it is at the desired height or level, the turnover flange 98 is bent inwardly and downwardly into place, as shown in FIG. 1, which further compacts the sealing material 20. In one non-limiting example, the turnover flange 98 is bent into place so that the sealing material 20, which includes aluminum oxide with a median particle size of 10 μm or less as the low extrusion powder material, is compressed to one of the following densities: at least 3.2 g/cm³; more preferably, at least 3.5 g/cm³; and, even more preferably, at least 3.94 g/cm³. If the sealing material 20 includes one or more additive material(s), such as forming aids (e.g., internal/external lubricants), the tamp pressure may be reduced to as low as about 50 Mpa and still achieve one of the densities listed above. The downward force with which the turnover flange 98 is bent is transferred into the tamped powder and helps compress the powder to a high density and lock the various components in place. However, since the sealing material 20 is largely made of a low extrusion powder material, material loss via extrusion through annular gap 124 is kept to a minimum.

According to a second method, sealing material 20 is first pressed into a preform, which is then inserted into the annular space 120 and tamped down, before the turnover flange 98 is bent into place, as described above. In this example, the preform may be formed using any suitable powder pressing technique, such as isostatic pressing, before it is inserted into annular space 120. It should be pointed out that any of the process parameters and techniques recited above in conjunction with the first manufacturing method, may be used with this second manufacturing method as well.

Spray drying and/or any other suitable granulation method may be optionally employed to better prepare the sealing material 20 for introduction into the annular space 120. For instance, aluminum oxide is typically spray dried or otherwise granulated so that it is more flowable, as it is usually too dusty. Other granulation methods may include hydrating the different powder materials to make them more uniform flowable powders.

It is to be understood that the foregoing is a description of one or more preferred example embodiments. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all the following: “A”; “B”; “C”; “A and B”; “A and C”; “B and C”; and “A, B, and C.”

1. A spark plug sealing material for sealing an annular space between a spark plug insulator and a spark plug shell, the sealing material comprising:
a low extrusion powder material having an internal friction that is higher than that of talc powder, wherein the low extrusion powder material is the single largest constituent of the sealing material on a wt % basis.

2. The spark plug sealing material of claim 1, wherein the low extrusion powder material is aluminum oxide (Al₂O₃).

3. The spark plug sealing material of claim 2, wherein the sealing material further comprises at least one additive material.

4. The spark plug sealing material of claim 3, wherein the at least one additive material is a reclaimed material from a process used to manufacture spark plug insulators.

5. The spark plug sealing material of claim 2, wherein the sealing material further comprises at least one binder material.

6. The spark plug sealing material of claim 5, wherein the at least one binder material is polyvinyl alcohol (PVA), polyethylene glycol (PEG), a PVA/PEG organic binder system, or a wax emulsion.

7. The spark plug sealing material of claim 1, wherein the sealing material is comprised of 90-99 wt % low extrusion powder material in the form of aluminum oxide (Al₂O₃), 0.5-5 wt % at least one binder material, and 0.5-5 wt % at least one additive material.

8. The spark plug sealing material of claim 1, wherein the low extrusion powder material has a median particle size of 10 μm or less.

9. The spark plug sealing material of claim 1, wherein the low extrusion powder material has an average particle shape that is generally solid, angular and rock-like.

10. The spark plug sealing material of claim 1, wherein the low extrusion powder material has a coefficient of friction that is from 0.5-0.7, inclusive.

11. The spark plug sealing material of claim 1, wherein the low extrusion powder material is at least one of: a material from the chemical system MgO·Al₂O₃·SiO₂ or silicon carbide (SiC).

12. The spark plug sealing material of claim 1, wherein the sealing material is designed to be compacted in the annular space between the spark plug insulator and the spark plug shell to a density of at least 80% of a theoretical density of the sealing material.

13. A spark plug, comprising:
a shell having an axial bore and an internal surface;
an insulator at least partially disposed within the axial bore of the shell and having an axial bore and an external surface;
a center electrode at least partially disposed within the axial bore of the insulator;
a ground electrode forming a spark gap with the center electrode;
an annular space located between the internal surface of the shell and the external surface of the insulator; and
a spark plug sealing material disposed within the annular space, wherein the sealing material includes a low extrusion powder material having an internal friction that is higher than that of talc powder, the low extrusion powder material is the single largest constituent of the sealing material on a wt % basis.

14. A method of manufacturing a spark plug, comprising the steps of:
providing a sealing material comprising a low extrusion powder material having an internal friction that is higher than that of talc powder, wherein the low extrusion powder material is the single largest constituent of the sealing material on a wt % basis;
introducing the sealing material into an annular space between a spark plug insulator and a spark plug shell;
tamping the sealing material down; and
bending a turnover flange into place so that the turnover flange presses against and further compacts the sealing material.

15. The method of claim 14, wherein the low extrusion powder material is aluminum oxide (Al₂O₃).

16. The method of claim 15, wherein the sealing material further comprises at least one additive material that is a reclaimed material from a process used to manufacture spark plug insulators.

17. The method of claim 15, wherein the sealing material further comprises at least one binder material that is polyvinyl alcohol (PVA), polyethylene glycol (PEG), a PVA/PEG organic binder system, or a wax emulsion.

18. The method of claim 14, wherein the introducing step further comprises forming the sealing material into a preform before introducing the preform into the annular space.

19. The method of claim 14, wherein the bending step further comprises bending the turnover flange into place so that the turnover flange presses against and further compacts the sealing material to a density of at least 80% of a theoretical density of the sealing material.
